(19) United States
(12) Patent Application Publication
(10) Pub. No.: US 2007/0183657 A1
(43) Pub. Date: Aug. 9, 2007

(54) Color-image reproduction apparatus

(75) Inventors: Kiyosumi Kidono, Aichi-ken (JP); Yoshiki Ninomiya, Nagoya-shi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: KABUSHIKI KAISHA TOYOTA CHUO KENKYUSHO, Aichi-ken (JP)

(21) Appl. No.: 11/649,359

(22) Filed: Jan. 4, 2007

(30) Foreign Application Priority Data
Jan. 10, 2006 (JP) 2006-002027

(51) Int. Cl. G06K 9/00

(52) U.S. Cl. 382/162

(57) ABSTRACT

A color-image reproduction apparatus reproduces a color image on the basis of digital image data which are obtained through detection of an image by visible light detection elements and an infrared detection element. Visible image data are extracted from the image data, and infrared-containing image data are extracted from the image data. Brightness information is extracted from the visible image data or infrared-containing image data. An infrared component is removed from the visible image data. Color information is extracted from the visible image data from which the infrared component has been removed. The brightness information and the color information are combined so as to generate a quasi color image.

### BACKGROUND OF THE INVENTION

1. Field of the Invention

The present invention relates to a color-image reproduction apparatus for reproducing a color image on the basis of digital image data which are obtained through detection of an image by visible light detection elements capable of detecting primary colors of visible light and an infrared detection element capable of detecting electromagnetic waves including infrared rays, and in which data representing each pixel are composed of a plurality of components in respective frequency bands.

2. Description of the Related Art

In a conventional technique disclosed in Japanese Patent Application Laid-Open (kokai) No. 2005-6066, of filters for four pixels (pixels for R, G, B, and G) which constitute one unit of a Bayer arrangement, one G filter (green color filter) is replaced with an IR filter (visible light cut off filter). The RGB filters are used for a first mode, and the IR filter is used for a second mode. in addition, infrared cut off filters are provided for the three pixels of RGB.

According to this scheme, the first mode is selected when the ambience is relatively bright (e.g., during daytime) so as to perform image reproduction processing by use of the three pixels of RGB, and the second mode is selected when the ambience is relatively dark (e.g., during nighttime) so as to perform image reproduction processing by use of one pixel of IR only. Thus, both improvement in color reproduction for bright objects and improvement in image-capturing sensitivity in a dark image-capturing environment can be achieved through software switching only.

However, in the above-described conventional technique, the color filters for the three primary colors and the infrared filter are selectively used in accordance with the reproduction mode. Therefore, when the ambience is dark (e.g., during nighttime), an image based on the infrared data (infrared component) only is reproduced. In such a case, only a monochrome image can be displayed.

### SUMMARY OF THE INVENTION

In view of the foregoing, an object of the present invention is to provide a color-image reproduction apparatus which can reproduce a color image having optimal color and brightness, on the basis of digital image data in which data representing each pixel are composed of a plurality of components in respective frequency bands.

In order to achieve the above-described object, according to a first aspect of the present invention, there is provided a color-image reproduction apparatus for reproducing a color image on the basis of digital image data which are obtained through detection of an image by visible light detection elements capable of detecting primary colors of visible light and an infrared detection element capable of detecting electromagnetic waves including infrared rays, and in which data representing each pixel are composed of a plurality of frequency band components, the apparatus comprising visible-image extraction means for extracting visible image data from the image data; infrared-containing-image extraction means for extracting infrared-containing image data from the image data; brightness-information extraction means for extracting brightness information from the visible image data or infrared-containing image data; infrared-component removal means for removing an infrared component from the visible image data; color-information extraction means for extracting color information from the visible image data from which the infrared component has been removed; and quasi-color-image generation means for combining the brightness information and the color information so as to generate a quasi color image.

The terms “reproducing” and “reproduction” encompass not only reproduction or playback of an image recorded on a recording medium, but also image processing for displaying in real time (live) a captured image on a display screen of an image display apparatus.

Although the visible image data are image data regarding the primary colors of visible light, the respective color component data contain an infrared component. However, the visible image data differ from the above-mentioned infrared-containing image data, and therefore, must be distinguished therefrom. The above-described infrared-component removal means is provided for the purpose of subtracting the infrared component contained in the visible image data.

The primary colors of visible light are arbitrarily selected. For example, in a case where visible light is produced from three primary colors, red, green, and blue may be used as the three primary colors. Alternatively, cyan, yellow, and magenta, which are complementary colors of these colors, may be selected. Further, a fourth primary color, such as emerald green (E), may be added to the former three primary colors (R, G, B), and a fourth primary color, such as green (G) may be added to the latter three primary colors (c, y, m). When the number of primary colors is increased, the apparatus becomes slightly more complex; however, color expression in a wider range becomes possible, and an apparatus which hardly causes deterioration of color due to, for example, noise or color conversion can be realized.

The infrared-containing image data may be image data of monochrome which is composed of white light containing red light, green light, and blue light and which includes infrared rays. In a case where the above-described primary colors of visible light are red, green, and blue, and the amount of the white light is substantially equal to that of the infrared rays, the brightness of cyan (c), which is the complementary color of red, can be obtained by subtracting the brightness of red light from the brightness of white light. This complementary-color-brightness calculation method, which is not necessarily required to be realized by the above-described simple subtraction processing, can be used to obtain the brightness of magenta (m), which is the complementary color of green and the brightness of yellow (y), which is the complementary color of blue.

Accordingly, the above-described infrared-component removal means may be realized by such a scheme. Further, in this case, cyan (c), magenta (m), and yellow (y), whose brightnesses are obtained in the above-described manner, can be used as the three primary colors of visible light. Thus, desired color information can be formed (extracted) from the data of these primary colors, not containing infrared rays.

Moreover, in a case where the above-described primary colors of visible light are cyan (c), magenta (m), and yellow (y), and the amount of the white light is substantially equal to that of the infrared rays, the brightness of red, which is the complementary color of cyan (c), can be obtained by subtracting the brightness of cyan (c) from the brightness of white light. This complementary-color-brightness calculation method can be used to obtain the brightness of green, which is the complementary color of magenta (m) and the brightness of blue, which is the complementary color of yellow (y).

Accordingly, the above-described infrared-component removal means may be realized by such a scheme. Further, in this case, red, green, and blue, whose brightnesses are obtained in the above-described manner, can be used as the three primary colors of visible light. Thus, desired color information can be formed (extracted) from the data of these primary colors, not containing infrared rays.

The above-described brightness information is not necessarily required to obtain from either the visible image data or the infrared-containing image data.

Although the above-described color information can be represented by two parameters; i.e., hue and saturation, definition (selection) of parameters which represent the color information is arbitrary. That is, in the present invention, any color space may be used, insofar as the color information and the brightness information can be separated through orthogonal separation in the selected color space. Examples of color spaces in which the color information and the brightness information can be separated through orthogonal separation include well-known HSV and YIQ spaces.

The above-described image data may be data acquired by use of a plurality of cameras provided for the respective wavelength bands, or data acquired by use of a single camera equipped with a color filter, such as that employed in the previously-described conventional technique.

In a case where four cameras in total are provided for four frequency bands of the three primary colors (red, green, and blue) of visible light and infrared rays, the above-described infrared-containing-image extraction means is only required to select the image data acquired by means of an infrared camera, which detects infrared rays. However, this selection operation is also considered to be an operation of “extracting infrared-containing image data.” This also applies to the extraction operation performed by the visible-image extraction means.

The above-described quasi color image is reproduced for an image of an image-capturing area for which respective image data have been acquired over the wavelength bands of the primary colors of visible light and infrared rays. Therefore, the quasi color image can be completely generated only for an area where all the image-capturing areas of the respective wavelength bands overlap one another. However, when a plurality of cameras are used for each of the respective image-capturing areas of the wavelength bands, areas in which images are captured by the cameras are not required to coincide with one another.

A color filter and photo detector may be divided into portions corresponding to the respective frequency bands, by means of planar area division. However, when the light-receiving element is configured to have a three-dimensional layer structure composed of a plurality of light-receiving layers for receiving the respective frequency band components, the light-receiving area of each light-receiving layer can be increased greatly as compared with the above-described case of area division.

According to a second aspect of the present invention, the infrared-component removal means according to the first aspect removes the infrared component from the visible image data on the basis of the infrared-containing image data and the transmission characteristic of a color filter used in image acquisition means.

Such an infrared-component removal means can be realized by a calculation processing circuit for processing the above-described visible image data or by a computer and software therefor.

According to a third aspect of the present invention, there is provided a color-image reproduction apparatus for reproducing a color image on the basis of digital image data which are obtained through detection of an image by visible light detection elements capable of detecting primary colors of visible light and an infrared detection element capable of detecting electromagnetic waves including infrared rays, and in which data representing each pixel are composed of a plurality of frequency band components, the apparatus comprising an infrared cut off filter for cutting an infrared-ray component contained in light received by the visible light detection elements; visible-image extraction means for extracting visible image data from the image data; infrared-containing-image extraction means for extracting infrared-containing image data from the image data; brightness-information extraction means for extracting brightness information at least from the infrared-containing image data; color-information extraction means for extracting color information from the visible image data; and quasi-color-image generation means for combining the brightness information and the color information so as to generate a quasi color image.

Needless to say, such an infrared cut off filter is provided in image acquisition apparatuses for acquiring the above-described visible image data corresponding to the primary colors of visible light. However, in a case where only a single image acquisition apparatus is used, such an infrared cut off filter is provided only in selected areas of a color filter used in the image acquisition means, which areas correspond to the primary colors of visible light.

According to a fourth aspect of the present invention, the brightness information extraction means according to the first or second aspect includes extraction-source selection means for selecting the visible image data or the infrared-containing image data as extraction source data from which brightness information is extracted.

The selection criteria are determined freely. For example, switching control may be performed such that the brightness information is extracted from the visible image data when the ambient environment is bright, and brightness information is extracted from the infrared-containing image data when the ambient environment is dark. Such switching control may be performed in response to user's selection operation. The determination as to whether the ambient environment is bright or dark may be performed through estimation from seasons, time of day, weather information, and/or information on the present position, or by use of an illuminance sensor.

According to a fifth aspect of the invention, the brightness-information extraction means according to any one of the first through third aspects includes first extraction means for extracting first brightness information from the visible image data, second extraction means for extracting second brightness information from the infrared-containing image data, and weighted-average calculation means for calculating, as the brightness information, the weighted average of the first brightness information and the second brightness information.

The weight (weighting ratio) of the first brightness information and the second brightness information for calculation of the weighted average may be freely determined. For example, the weight may be variably controlled in such a manner that a greater weight is given to the first brightness information when the ambient environment is bright, and a greater weight is given to the second brightness information when the ambient environment is dark. Such viable control may be performed in accordance with user's selection operation. The determination as to whether the ambient environment is bright or dark may be performed through estimation from seasons, time of day, weather information, and/or information on the present position, or by use of an illuminance sensor.

According to a sixth aspect of the present invention, there is provided an image reproduction apparatus which reproduces an image on the basis of image data containing an infrared component and which includes the color-image reproduction apparatus according to any one of the first through fifth aspects of the invention, further comprising display-area-division definition means for dividing a display area for a reproduced image into a color-image display area and a monochrome-image display area. Color display is performed in the color-image display area on the basis of digital image data which are obtained through detection of an image by visible light detection elements capable of detecting primary colors of visible light and an infrared detection element capable of detecting electromagnetic waves including infrared rays, and in which data representing each pixel are composed of a plurality of frequency band components. Monochrome display is performed in the monochrome-image display area on the basis of the image data containing the infrared component only. The quasi color image is displayed in the color-image display area by the color-image reproduction apparatus.

The following effects are achieved by the above-described aspects of the present invention.

That is, according to the first aspect of the present invention, the above-described image data can be properly separated into color information and brightness information for individual processing, which can be combined so as to reproduce an image. At this time, the infrared component of the visible image data is removed by means of the infrared-ray removal means. Accordingly, according to the first aspect, the adverse effect of the infrared component on the color information can be effectively removed from the reproduced image, so that the reproduced image is prevented from becoming excessively whitish or from becoming excessively dark because of uniform infrared-ray elimination processing. Therefore, it becomes possible to properly maintain the original color information contained in the above-described input image data and impart to such color information optimal brightness information properly including that of the infrared component. That is, it becomes possible to reproduce and display a desired quasi color image which contains the largest amount of brightness information, without distorting the color information by the infrared component.

Accordingly, according to the first aspect of the present invention, it becomes possible to reproduce a color image which is optimal in color and brightness on the basis of digital image data in which data of each pixel are composed of a plurality of frequency band components.

According to the second aspect of the present invention, the infrared component can be removed from the visible image data by means of logical data processing. Therefore, it becomes unnecessary to provide an infrared cut off filter in the image acquisition apparatus. Alternatively, it becomes possible to process image data acquired or recorded by use of an image acquisition apparatus not equipped with an infrared cut off filter. Further, when an infrared cut off filter is used, the sensitivity of the image acquisition apparatus drops. However, according to the second aspect of the present invention, such a drawback can be solved.

According to the third aspect of the present invention, the action and effect similar to those attained by the first aspect of the present invention can be attained, although in some cases the sensitivity of the image acquisition apparatus drops slightly. In addition, equivalent alternative means for the infrared-ray removal means according to the first aspect can be realized quite simply by means of the above-described physical means (infrared cut off filter).

According to the fourth aspect of the present invention, the above-described brightness information can be calculated on the basis of more proper extraction source data, which are selected from the visible image data and the infrared-containing image data. For example, during nighttime, a large quantity of visible light is difficult to obtain. In such a case, selection of the infrared-containing image data may be desirable.

According to the fifth aspect of the present invention, the brightness information can be calculated as a value which changes continuously or stepwise in accordance with the brightness of the ambient environment.

For example, when the sum of the weight W1 for the first brightness information and the weight W2 for the second brightness information is 1, the weight w1 is set to 1 for the fine daytime, is set to 0 for the dark nighttime, and is set to a value between 1 and 0 for an ambience therebetween, whereby the weight w1 is changed continuously or stepwise. Thus, a quasi color image suitable for the brightness of the ambient environment can be generated. When the weight w1 is changed stepwise, the number of steps may be preferably set to three or more.

Although an example in which the weight w1 varies within the range of 1≧w1≧0 has been described, no restriction is imposed on the method of calculating the weighted average associated with the brightness information.

According to the sixth aspect of the present invention, since a large amount of an infrared component is contained in the visible image data and the infrared-containing image data, from which the brightness information is extracted, a marked difference in brightness between monochrome and color images is not produced at the boundary between a monochrome-image display area and a color-image display area. Therefore, according to the sixth aspect of the present invention, unnatural sensation does not arise from discontinuity in brightness at the boundary between the two image display areas.

For example, in a case where the infrared-containing image data are selected as extraction source data in the fourth aspect or in a case where the weight (w1) of the first brightness information is set to zero in the fifth aspect when the brightness information is included in the infrared-containing image data more than in the visible image data, the difference in brightness between the images at the boundary between the two image display areas can be effectively eliminated. That is, when the processing according to the sixth aspect is performed, while taking into account the effect of eliminating the brightness difference which produces a brightness discontinuity (unnatural sensation) at the boundary between the two areas, the color-image reproduction apparatus according to any one of the first through fifth aspects which is used in the image production apparatus according to the sixth aspect is desirably configured to calculate the above-described brightness information on the basis of the infrared component or the image data containing the infrared component in a large amount.

The image reproduction apparatus (according the sixth aspect) may be mounted on a vehicle so as to display an image ahead of the vehicle on a predetermined display apparatus in combination with additional headlights emitting only infrared rays and an infrared camera. In this case, an infrared-ray monitoring area can be set all the time to coincide with a so-called high-beam radiation area of the ordinary headlights. Therefore, of the high-beam radiation area (infrared-ray radiation area), an area outside a so-called low-beam radiation area of the ordinary headlights (i.e., an area which is monitored only by use of infrared rays) is desirably set to coincide with the monochrome-image display area according to the sixth aspect.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompanying drawings, in which:

FIG. 1 is a plan view of a color filter used in an embodiment of the present invention;

FIG. 2 is a graph showing transmission characteristics of respective pixel filters of the color filter;

FIG. 3 is a block diagram of a color-image reproduction apparatus according to the embodiment; and

FIG. 4 is a block diagram of an image reproduction apparatus according to the embodiment.

### DESCRIPTION OF THE PREFERRED EMBODIMENT

An embodiment of the present invention will be described with reference to the drawings.

However, the present invention is not limited to the embodiment and its modifications described below.

### Embodiment

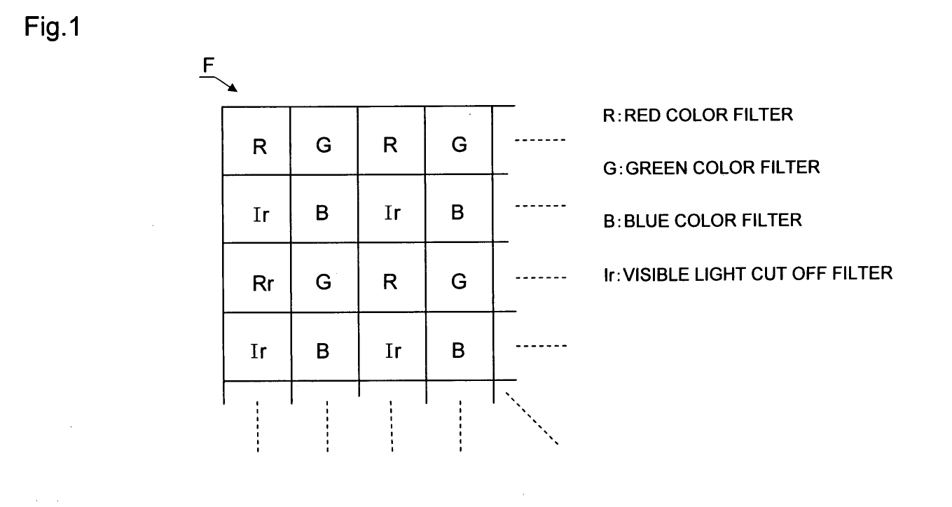

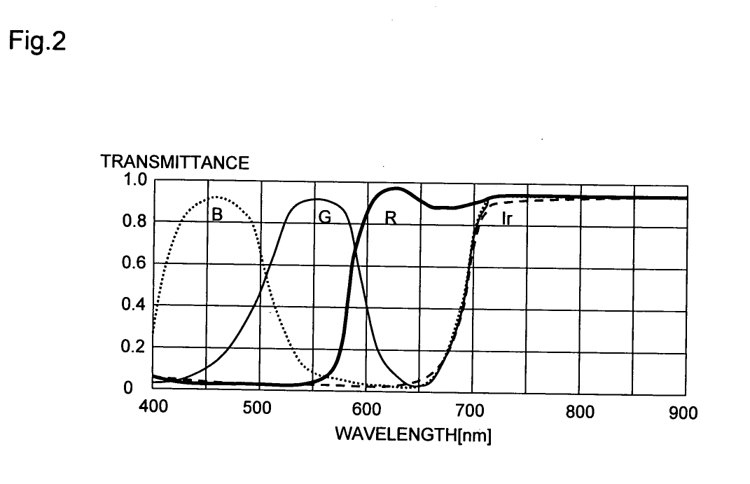

FIG. 1 shows plan view of a color filter F used in an embodiment of the present invention. Of pixel filters disposed in a pixel-by-pixel fashion, a red color filter (pixel filter) R transmits red light and infrared rays, a green color filter (pixel filter) G transmits green light and infrared rays, and a blue color filter (pixel filter) B transmits blue light and infrared rays. An visible light cut off filter (pixel filter) Ir transmits infrared rays only. Each of these filters corresponds to a single pixel. FIG. 2 shows the transmission characteristics of respective pixel filters (R, G, B, Ir) of the color filter F of FIG. 1. Each single dot on an image is composed of four pixels of the above-described R, G, B, Ir. Such a color filter F is typically interposed between a lens and an image sensor of an image-capturing apparatus.

Next, there will be described means for reproducing image data acquired by use of such a color filter F, as well as the steps of operating the means.

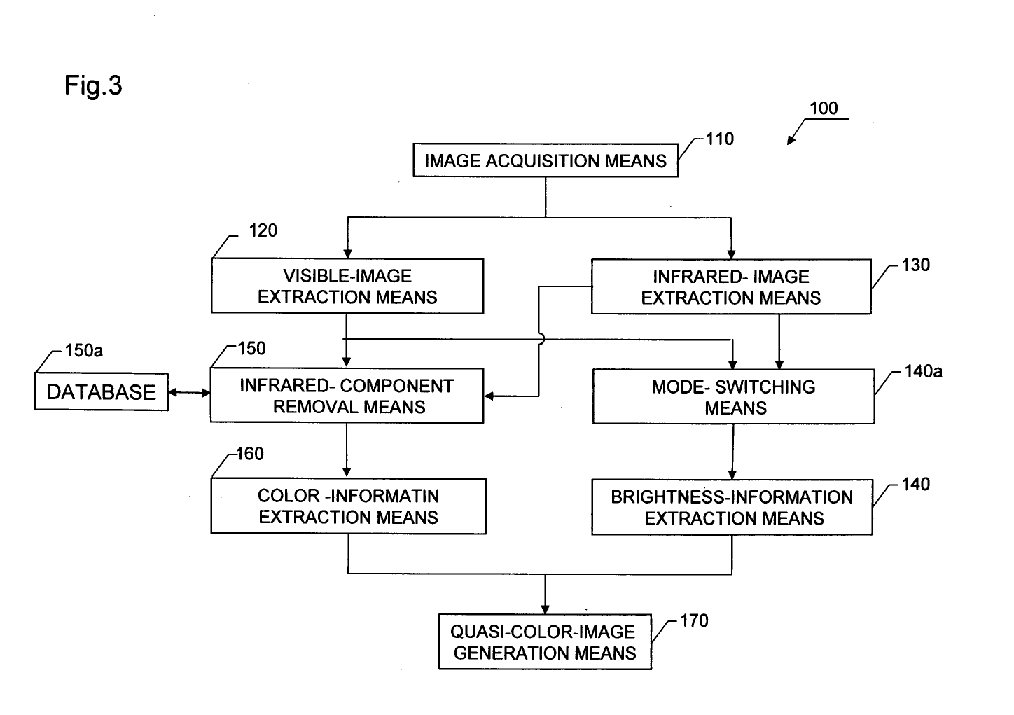

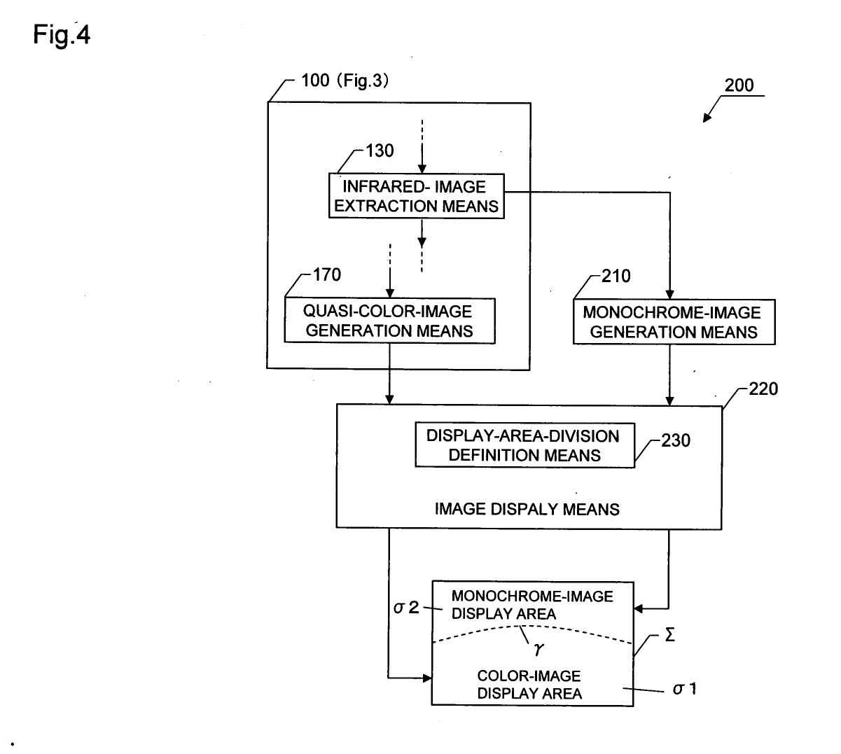

FIG. 3 is a block diagram of a color-image reproduction apparatus 100 according to the embodiment. In this color-image reproduction apparatus 100, the infrared component is removed from the RGB components (visible-light components) in order to obtain accurate color information. However, brightness information is calculated from the RGB components containing the infrared component, in order to prevent generation of a brightness difference, which would otherwise be generated in the vicinity of a boundary γ between a color section σ1 and a monochrome section σ2 in a finally reproduced image displayed on a display screen Σ as shown in FIG. 4. It is desirable to extract the brightness information from the RGB components containing the infrared component more than from the infrared image data in view of increasing a sensitivity of the image displayed.

Image acquisition means 110 of FIG. 3 is adapted to acquire image data, which are classified into four wavelength bands; i.e., wavelength bands corresponding to red light, green light, blue light, and infrared rays, respectively, by use of the above-described color filter F including four types of pixel filters (R, G, B, Ir). This image acquisition means 110 may be an image-capturing apparatus, such as a camera, which acquires image data of an object directly therefrom, or a data read-out apparatus for acquiring image data from a recording medium of a predetermined form. In the embodiment, the image acquisition means 110 is an image-capturing apparatus having the above-described color filter F between a lens and an image sensor thereof.

The remaining means which are illustrated as various control blocks, from control block 120 to control block 170, can be realized by means of software of a computer, and are realized by, for example, a control program and an application program, their subroutines and instruction steps, and/or optical data on a recoding medium.

However, needless to say, these information processing means can be realized at least partially by means of hardware circuits such as an analog circuit and a digital circuit.

Visible-image extraction means 120 (FIG. 3) at the next stage is adapted to extract, from the image data acquired by the image acquisition means 110, only image data representing the respective received light quantities of pixels corresponding to the visible light transmission filters (the pixel filters R, G, B) which transmit the visible light components. Hereinafter, this image data will be referred to as “visible image data.”

Meanwhile, infrared image extraction means 130 of FIG. 3, which is provided in parallel with the visible-image extraction means 120, extracts, from the acquired data, only image data representing the respective received light quantities of pixels corresponding to the Ir filters. Hereinafter, this image data will be referred to as “infrared image data.”

Mode-switching means 140a at the next stage selects one of the above-described two image data sets (the visible image data and the infrared image data) in accordance with a designated mode. For example, during nighttime, when visible light is hardly received, the infrared image data are selected, and in other cases the visible image data are selected. This mode-switching means 140a can be considered to realize a portion of the functions of brightness-information extraction means 140 at the next stage.

The brightness-information extraction means 140 at the next stage extracts brightness information from the visible components (R, G, B) containing the infrared component when the mode-switching means 140a selects the visible image data. Otherwise, the brightness-information extraction means 140 extracts brightness information from the infrared image data when the mode-switching means 140a selects the infrared image data. As in the case of the color-information extraction means, only the brightness component is extracted by making use of a color space such as HSV when the visible components (R, G, B) containing the infrared component is used for the brightness information. Hereinafter it is described for the case that the brightness-information extraction means 140 extracts brightness information from the visible components (R, G, B) containing the infrared component.

Further, infrared-component removal means 150 of FIG. 3 is adapted to estimate the amount of the infrared component having passed through each of the RGB filters and remove the infrared component. For this estimation, the pixel values of the infrared image data obtained by means of the infrared-image extraction means and information of a database 150a are used. This database 150a holds information necessary for removal of the infrared component; for example, the filter characteristics of the image-capturing apparatus as shown in FIG. 2; the ratio of the infrared component passing through each of the pixel filters (R, G, B) of the visible light region to the total transmission amount; and infrared-component transmission ratios FR, FG, and FB for infrared rays having a certain standard wavelength; i.e., the ratios FR, FG, and FB of infrared-component transmission amounts IrR, IrG, and IrB of the pixel filters (R, G, B) to the infrared-ray transmission amount Irs of the visible light cut off filter Ir (FR=IrR/Irs, FG=IrG/Irs, FB=IrB/Irs).

For example, in a case where the transmission characteristic of a color filter to be used is given by the graph of FIG. 2, the amount of infrared rays passing through the visible light cut off filter Ir is equal to the amount of the infrared component passing through each of the pixel filters (R, G, B). Therefore, a difference value obtained by subtracting the amount of light received by the pixel with the visible cut off filter Ir from the amount of light received by the pixel with the red color filter can be considered to be the true (correct) received light amount for the red component at the associated pixel. Further, when the ratios FR, FG, and FB of infrared-component transmission amounts of the pixel filters (R, G, B) to the infrared-ray transmission amount of the visible light cut off filter Ir for infrared rays having the certain standard wavelength are not 1, the actual infrared component passing through the pixel filters (R, G, B) at an arbitrary dot can be obtained as described below. When the actual amount of infrared rays having been transmitted through the visible light cut off filter Ir at an arbitrary dot on an image is represented by Irm, the actual infrared components passing through the pixel filters (R, G, B) at that dot can be obtained by multiplying the actual infrared-ray transmission amount Irm by the respective ratios FR, FG, and FB; i.e., through respective multiplication operations Irm·FR, Irm·FG, and Irm·FB. The true R, G, and B values can be obtained by subtracting the respective infrared components Irm·FR, Irm·FG, and Irm·FB from the respective light transmission amounts of the pixel filters ,i.e., color filter (R, G, B) at each pixel.

The calculation scheme for obtaining the true (correct) received light amount for each color component is not necessarily simple as in the above-described case. The calculation scheme may depend on the transmission characteristics of individual color filters, or the overall tendency of color bias in the image-capturing environment. However, it is quite possible or easy to empirically optimize such a calculation scheme.

Color-information extraction means 160 converts image data in the RGB space to those in a HSV space (or any other color space such as a YIQ space) so as to facilitate exaction of color information from the infrared-component-removed visible components (that is, visible image data after removal of the infrared component). In the present embodiment, the HSV space is employed. In the HSV space, each pixel is represented by three coordinate values; i.e., hue, saturation, and brightness (lightness). Therefore, in the color-information extraction means 160, the hue and saturation, which are pieces of color information, are extracted, and sent to quasi-color-image generation means 170 at the next stage.

The quasi-color-image generation means 170 at the final stage of the color-image reproduction apparatus 100 generates a quasi color image by combining the color information and the brightness information of each pixel extracted at the previous stage (the extraction means 140 and 160). That is, the hue and saturation information obtained by means of the color-information extraction means 160 and the brightness information obtained by means of the brightness-information extraction means 140 are combined, and the resultant data are inversely converted to those in the RGB space, whereby a quasi color image can be obtained.

Although the color-image reproduction apparatus 100, whose structure and operation have been described above, can be used as a stand-alone apparatus, the color-image reproduction apparatus 100 can be used as a part of an image reproduction apparatus 200, which can display a monochrome image and a color image simultaneously on a single screen as described below.

FIG. 4 is a block diagram of the image reproduction apparatus 200 according to the embodiment, which includes the above-described color-image reproduction apparatus 100. Monochrome-image generation means 210 receives infrared image data from the infrared image extraction means 130 of the color-image reproduction apparatus 100, and generates a monochrome image on the basis of the infrared image data.

Image display means 220 displays a desired image on the display screen Σ formed of, for example, a liquid-crystal panel, and includes display-area-division definition means 230. This display-area-division definition means 230 determines (defines) on the display screen Σ the above-described boundary γ between the color section σ1 and the monochrome section σ2. In the example of FIG. 4, a region above the boundary line is defined as a monochrome-image display area σ2, and a region below the boundary line is defined as a color-image display area σ1.

For example, such an image reproduction apparatus 200 can be mounted on a vehicle in combination with additional headlights emitting infrared rays only and an infrared camera. In this case, an infrared-ray monitoring area can be set to coincide at all times with a so-called high-beam radiation area of the ordinary headlights. Therefore, of the high-beam radiation area (infrared-ray radiation area), an area outside a so-called low-beam radiation area of the ordinary headlights (i.e., an area which is monitored by use of infrared rays only) desirably coincides with the monochrome-image display area σ2.

In this case, it is more desirable that the mode-switching means 140a of FIG. 3 selects the visible image data obtained by means of the visible-image extraction means 120 regardless of the fine day time or the dark night time in view of increasing sensitivity of the image displayed. In such a case, the high-sensitivity brightness information over a wide frequency range can be employed. In addition, since the visible image data are data before removal of the infrared component, the brightness difference between the image display areas σ1 and σ2 (in particular, in the vicinity of the boundary γ) does not stand out markedly.

Meanwhile, when the mode-switching means 140a selects the infrared image data extracted by means of the infrared image extraction means 130, a continuous image in terms of brightness in the vicinity of the boundary γ can be reproduced on the display screen Σ. However, the quality of the quasi color image reproduced in the color-image display area σ1 may deteriorate slightly.

[Modifications]

The present invention is not limited to the above-described embodiment, and may be modified as illustrated below. Such modified embodiments provide the same action and effects as those of the above-described embodiment.

First Modification:

In the above-described embodiment, the mode-switching means 140a is provided. However, the brightness-information extraction means 140 may be configured to fixedly use either the visible image data output from the visible-image extraction means 120 or the infrared image data output from the infrared image extraction means 130.

Alternatively, the brightness-information extraction means 140 may be configured to obtain two brightness value sets (first brightness information and second brightness information of the present invention) from the visible image data and the infrared image data, obtain a set of weighted averages of the brightness values, and transfer them to the quasi-color-image generation means 170 as the final output information (desired brightness information) of the brightness-information extraction means 140.

Here, the weight for the first brightness information is represented by w1, the weight for the second brightness information is w2, and the sum (w1+w2) of the weights is 1. The weight w1 is set to 1 for the fine daytime, is set to 0 for the dark nighttime, and is set to a value between 1 and 0 for an ambience therebetween, whereby the weight w1 is changed continuously or stepwise. Thus, a quasi color image suitable for the brightness of the ambient environment can be produced. When the weight w1 is changed stepwise, the number of steps is preferably set to three or more.

In the above-described example, in which the weight w1 varies within the range of 1≧w1≧0, an arbitrary method is employed for calculating the weighted average value associated with the brightness information. For example, if the weight between the visible light (RGB components) and the infrared rays (IR component) is fixed to a constant value in the brightness-information extraction means 140, the image data is not necessarily required to be separated into the RGB components and the Ir components by means of the image extraction means 120 and 130. For example, the desired brightness information can be easily determined directly from the image data (R, G, B, Ir), which are output data of the image acquisition means 110, through linear calculation such as a·R+b·G+c·B+d·Ir.

Second Modification:

In the above-described embodiment, the infrared-component removal means 150 of FIG. 3 is used. However, the infrared-component removal means of the present invention may be realized by use of a physical infrared cut filter (the third aspect of the present invention). In this case, the camera sensitivity may lower slightly because of the characteristics of the filter. However, since the infrared-component removal means 150 and the database 150a of FIG. 3 can be omitted, the structure of the apparatus can be simplified.

Third Modification:

In the above-described embodiment, the color filter F is provided for a single image-capturing apparatus. However, the embodiment may be configured to acquire image data by use of a plurality of cameras. In this case, a filter attached to each camera does not have to be divided into the pixel unit. Alternatively, an imaging area per primary color can be increased. In particular, in a case where each camera receives only one frequency band component; i.e., one primary color or infrared rays, each camera is required to have an optical filter having one of the above-described R, G, B, and Ir filter characteristics. In addition, the increased number of cameras improves the resolution of a reproduced image.

Fourth Modification:

Even when an image is captured by use of a single camera, the imaging area, i.e., light-receiving area is not necessarily required to be divided, by means of planar area division, so as to correspond to the respective frequency band components of the color filter or the image sensor to be used. For example, when the image sensor is configured to have a three-dimensional layer structure composed of a plurality of imaging layers, i.e., light-receiving layer for receiving the respective frequency band components, the imaging area of each imaging layer can be increased greatly as compared with the above-described case of area division. This structure also improves the resolution of a reproduced image.

Fifth Modification:

In the above-described embodiment, the image data of the infrared containing image of the present invention are extracted by means of the infrared image extraction means 130 of FIG. 3. However, the image data of the infrared containing image are not necessarily required to be image data of infrared rays only. For example, the image data which constitute an infrared containing image may be image data of a monochrome image of white light containing all the frequency bands of red light, green light, blue light, and infrared rays.

In this case, three-color filters which transmit three colors; i.e., cyan (c), magenta (m), and yellow (y), individually, may be used as color filters for transmitting the primary colors of visible light. In this case, when each of the three-color filters transmits infrared rays in generally the same amount as that of the above-described white light, the brightness of red light can be obtained by subtracting the brightness of cyan (c) from the brightness of the white light. The brightnesses of green light and blue light can be obtained in a similar manner.

Accordingly, the infrared-component removal means of the present invention may be configured by a data-processing section which performs such subtraction processing.

What is claimed is:

1. A color-image reproduction apparatus for reproducing a color image on the basis of digital image data which are obtained through detection of an image by visible light detection elements capable of detecting primary colors of visible light and an infrared detection element capable of detecting electromagnetic waves including infrared rays, and in which data representing each pixel are composed of a plurality of frequency band components, the apparatus comprising:
visible-image extraction means for extracting visible image data from the image data;
infrared-containing-image extraction means for extracting infrared-containing image data from the image data;
brightness-information extraction means for extracting brightness information from the visible image data or infrared-containing image data;
infrared-component removal means for removing an infrared component from the visible image data;
color-information extraction means for extracting color information from the visible image data from which the infrared component has been removed; and
quasi-color-image generation means for combining the brightness information and the color information so as to generate a quasi color image.

2. A color-image reproduction apparatus according to claim 1, wherein the infrared-component removal means removes the infrared component from the visible image data on the basis of the infrared-containing image data and the transmission characteristic of a color filter used in image acquisition means.

3. A color-image reproduction apparatus for reproducing a color image on the basis of digital image data which are obtained through detection of an image by visible light detection elements capable of detecting primary colors of visible light and an infrared detection element capable of detecting electromagnetic waves including infrared rays, and in which data representing each pixel are composed of a plurality of frequency band components, the apparatus comprising:
an infrared cut off filter for cutting an infrared-ray component contained in light received by the visible light detection elements;
visible-image extraction means for extracting visible image data from the image data;
infrared-containing-image extraction means for extracting infrared-containing image data from the image data;
brightness-information extraction means for extracting brightness information at least from the infrared-containing image data;
color-information extraction means for extracting color information from the visible image data; and
quasi-color-image generation means for combining the brightness information and the color information so as to generate a quasi color image.

4. A color-image reproduction apparatus according to claim 1, wherein the brightness information extraction means includes extraction-source selection means for selecting the visible image data or the infrared-containing image data as extraction source data from which the brightness information is extracted.

5. A color-image reproduction apparatus according to claim 1, wherein the brightness-information extraction means includes first extraction means for extracting first brightness information from the visible image data, second extraction means for extracting second brightness information from the infrared-containing image data, and weighted-average calculation means for calculating, as the brightness information, the weighted average of the first brightness information and the second brightness information.

6. A color-image reproduction apparatus according to claim 3, wherein the brightness-information extraction means includes first extraction means for extracting first brightness information from the visible image data, second extraction means for extracting second brightness information from the infrared-containing image data, and weighted-average calculation means for calculating, as the brightness information, the weighted average of the first brightness information and the second brightness information.

7. An image reproduction apparatus which reproduces an image on the basis of image data containing an infrared component, comprising:
the color-image reproduction apparatus according to claim 1; and
display-area-division definition means for dividing a display area for a reproduced image into a color-image display area and a monochrome-image display area, wherein color display is performed in the color-image display area on the basis of digital image data which are obtained through detection of an image by visible light detection elements capable of detecting primary colors of visible light and an infrared detection element capable of detecting electromagnetic waves including infrared rays, and in which data representing each pixel are composed of a plurality of frequency band components, and monochrome display is performed in the monochrome-image display area on the basis of the image data containing the infrared component only,
wherein the quasi color image is displayed in the color-image display area by the color-image reproduction apparatus.

8. An image reproduction apparatus which reproduces an image on the basis of image data containing an infrared component, comprising:
the color-image reproduction apparatus according to claim 3; and
display-area-division definition means for dividing a display area for a reproduced image into a color-image display area and a monochrome-image display area, wherein color display is performed in the color-image display area on the basis of digital image data which are obtained through detection of an image by visible light detection elements capable of detecting primary colors of visible light and an infrared detection element capable of detecting electromagnetic waves including infrared rays, and in which data representing each pixel are composed of a plurality of frequency band components, and monochrome display is performed in the monochrome-image display area on the basis of the image data containing the infrared component only,
wherein the quasi color image is displayed in the color-image display area by the color-image reproduction apparatus.
